(19) United States
(12) Patent Application Publication
(10) Pub. No.: US 2026/0169646 A1
(43) Pub. Date: Jun. 18, 2026

(54) METHOD FOR CARRYING OUT A DATA RECORDING, METHOD FOR GENERATING A DATA STREAM, APPARATUSES FOR DATA PROCESSING, COMPUTER PROGRAM PRODUCT, SIGNAL SEQUENCE, AND STORAGE MEDIUM

(71) Applicant: dSPACE GmbH, Paderborn (DE)

(72) Inventor: Bjoern MEYER, Paderborn (DE)

(73) Assignee: dSPACE GmbH, Paderborn (DE)

(21) Appl. No.: 19/094,212

(22) Filed: Mar. 28, 2025

(30) Foreign Application Priority Data
Dec. 13, 2024 (DE) 10 2024 137 656.2

(51) Int. Cl. G06F 3/06

(52) U.S. Cl. CPC G06F 3/0646; G06F 3/0604; G06F 3/0679; G06F 3/0683

(57) ABSTRACT

A method for carrying out a data recording is provided. Also, a method is provided for generating a data stream from elementary data units stored in a manner distributed over at least two storage media or source files, in particular using a data recording method of this type. Also, an apparatus for data processing, a computer program product, a signal sequence, and a storage medium are provided.

### BACKGROUND OF THE INVENTION

This nonprovisional application claims priority under 35 U.S.C. § 119(a) to German Patent Application No. 10 2024 137 656.2, which was filed in Germany on Dec. 13, 2024, and which is herein incorporated by reference.

### Field of the Invention

The present invention relates to a method for carrying out a data recording. The present invention also relates to a method for generating a data stream made up of stored elementary data units distributed over at least two storage media or source files, which are generated, in particular, by means of a data recording method of this type. The present invention further relates to apparatuses for data processing, a computer program product, a signal sequence, and a storage medium.

### Description of the Background Art

The data-driven development of applications for advanced driver assistance systems (ADAS) and autonomous driving (AD) require the use of vehicle and surroundings data which are as realistic as possible. To obtain the latter, sensor data from, for example, lidar, radar, and camera sensors having a very large bandwidth are read in during test drives and stored for use later on.

To be able to provide the necessary bandwidth for a simultaneous recording of multiple data streams from different sensors, a RAID controller, for example, has in the past been used to store the incoming data in RAID0 mode without redundancies, distributed to multiple hard disks. This approach has, in principle, also been proven to be successful up to now. However, a RAID controller of this type is comparatively expensive and accounts for a significant portion of the cost of a corresponding system for recording data.

### SUMMARY OF THE INVENTION

It is therefore an object of the present invention to overcome the described disadvantages of the prior art and, in particular, to specify an apparatus with the aid of which a simultaneous recording of multiple data streams from different sources is possible at high bandwidth in a cost-effective, yet easy and reliable manner.

According to a first aspect, the object is achieved by the invention in that a method for carrying out a data recording is proposed, at least one data stream being received for recording the data thereof, at least one specific data stream being included therein, each specific data stream being divided into elementary data units, on the basis of a data stream description predefined for the particular specific data stream, and the elementary data units of all specific data streams being stored in a manner distributed to at least two storage media.

The invention is thus based on the finding that the received specific data streams are each predictable to a high degree with respect to one or multiple properties. By using data stream descriptions of the specific data streams, this advance knowledge may be incorporated into elementary data units during the division of the specific data streams. At the same time, pieces of information about the quantity of elementary data units received per data stream and time unit, and thus about the total data quantity received per time unit and to be stored, may be known in advance or, in any case, at least be partially ascertainable.

Resources for processing and storing the data of the specific data streams may be coordinated in advance thereby, at least partially based on and/or proceeding from the data stream descriptions. For example, memory areas (such as in a random-access memory) for a buffering of received data (in particular, data of individual elementary data units) may be planned in advance, suitably dimensioned (for example, with regard to storage size and/or temporal availability), and/or reserved. Memory areas on the individual storage media for the expected elementary data units to be stored in a distributed manner, and/or bandwidths for write access to the individual storage media, may be at least implicitly planned, suitably dimensioned, and/or assigned thereby.

Due to this at least partial predictability of the received data quantity to be stored, the ability of a RAID controller to dynamically assign incoming data to hard disks may be dispensed with. As a result, the data recording may be advantageously carried out with the aid of the proposed method without using a RAID controller. The costs conventionally associated with the RAID controller may be saved thereby.

It may be particularly advantageously provided that the distributed storage of the elementary data units is at least partially carried out with the aid of a temporally parallel write access to the at least two storage media. In each case, a different elementary data unit is advantageously stored in each of the two storage media during this process. For example, a first elementary data unit of a first specific data stream is stored on a first storage medium of the at least two storage media, and a second elementary data unit (of either the first specific data stream or a second specific data stream) is stored temporally in parallel thereto on a second storage medium of the at least two storage media. Due to the parallel write access, the data of specific data streams may also be reliably stored at high bandwidth, in particular in real time. Although the permissible total bandwidth with respect to the received specific data streams may then be advantageously scaled linearly with the bandwidths (for the write access) of the individual storage media. For example, in the case of S storage media, which each permit a write access at a maximum data rate of R (bits/second) during a storage operation, the received specific data streams theoretically have a data rate in sum of S*R. By providing multiple storage media to which a parallel write access takes place, the permissible maximum total data rate of the specific data streams may therefore be increased.

Within the meaning of this application, “real time” can be understood to be the fact that the time period between the arrival of a first elementary data unit of the data stream and the arrival of a directly following second elementary data unit of the same data stream, i.e., the period length of the elementary data units of the data stream, is longer than the time period between the arrival of the first elementary data unit and the completion of the storage operation of the first elementary data unit on a storage medium. For example, it is possible to check whether or not this real-time condition has been met or is able to be met on the basis of the data stream description and/or another technical description of the data streams (for example, in relation to the arrival frequency and the size of the elementary data units) and/or the writing speed of the storage media.

Due to the comparatively easy implementability of the proposed method, conventional storage approaches may also be particularly easily adapted accordingly, and they may therefore benefit from the advantages described, in particular the cost savings. This makes the proposed method particularly interesting from an economical standpoint.

The elementary data units of all specific data streams are preferably stored in a distributed manner on two, three, four, five, or on more than five storage media (for example, on 10 or more than 10, or on 20 or more that 20, storage media).

The individual storage media are advantageously addressable individually (for example, to write data to the individual storage media during the data recording and/or to read data from the individual storage media). The individual storage media may be provided within one storage unit. For example, the individual storage media may be secured against loss. For example, the storage media may be connected to each other for this purpose in such a way that they may not be indestructibly separated from each other. The storage media may be designed for this purpose, for example, in the form of a closed memory module. The storage media are each preferably implemented by a solid-state disk (SSD).

The proposed method is preferably carried out entirely or partially on a data logger. The data logger may be, for example, part of an in-vehicle data acquisition or prototyping system. The method may also be advantageously carried out on a distributed system.

The proposed method is, for example, entirely or partially computer-implemented.

The proposed method may preferably be used to read in, process, and/or record data from sensors, such as lidar, radar, and/or camera sensors, and/or data from automotive buses and networks, in particular at high bandwidth in each case. Sensor data may be, for example, sensor raw data. In the case of received specific data streams within the meaning of this application, a high bandwidth is present, for example, at data rates of more than 1 Gbit/second. At least one of the at least one specific data streams therefore preferably has a data rate of more than 1 Gbit/second.

In summary, the proposed method thus permits a storage of (specific) data streams even of high bandwidth on multiple storage media. As a result, the necessary bandwidth for a simultaneous recording of multiple data streams from different sensors may be provided even during a test drive. The proposed method is therefore particularly advantageously suitable for the data-driven development of applications for driver assistance systems and autonomous driving. For example, the stored data may be subsequently used to train a neural network, to stimulate driver assistance systems, or they may be used as a template for virtual traffic scenarios to test a driver assistance system in a virtual environment.

It should be noted that one or multiple of the received data streams may also be processed and/or stored in a manner other than described here, in each case this then not being a specific data stream.

It may also be provided that the specific data streams are each received continuously and divided into elementary data units.

Due to the continuous receipt and continuous division, no resources need to be provided for buffering data of the specific data streams or only to a limited extent. This permits a particularly economical implementation of the method. In addition, latencies between the receipt and storage of the data may be reduced, and the data recording may thus be carried out more efficiently.

It may also be provided that two or more than two data streams are received, two or more than two specific data streams being included therein, which are received, in particular, at least partially temporally in parallel.

As a result, data streams from multiple sources (in particular sensors) may be received and stored simultaneously. The number of specific data streams preferably corresponds to the number of received data streams.

It may also be provided that the data stream descriptions predefined for the individual specific data streams, each have one or multiple technical specifications of the particular specific data stream, based on which the division of the particular data stream into elementary data units is at least partially carried out.

The division of the individual specific data streams into the elementary data units and/or the processing of the data may be carried out thereby, taking into account the particular technical specifications of the particular specific data stream.

As a result, each specific data stream may be handled individually and divided into elementary data units, taking into account its particular properties, and the elementary data units obtained thereby may be processed. Specific data streams from different sources may be efficiently processed in this manner (in particular, divided into elementary data units in each case) and stored, using at least partially different technical specifications.

The technical specifications of the specific data streams may each be entirely or partially known in advance. For example, they may be predefined manually. The technical specifications of the specific data streams may also be ascertained entirely or partially in an automated manner. For example, they may be ascertained by a communication with the particular source (such as a sensor) of the specific data stream. The automated ascertainment advantageously takes place prior to the data recording and/or at the beginning of the data recording. The data stream descriptions of the individual specific data streams may be (in particular, subsequently) at least partially ascertained at least partially manually and/or at least particular in an automated manner on the basis of the technical specifications.

An identical and/or common data stream description may advantageously be used for at least two specific data streams. This is possible, in particular, if the particular specific data streams come from sources of the same structural type.

It may also be provided that the data stream descriptions predefined for the individual specific data streams each include pieces of information about (i) a storage size of an elementary data unit of the particular specific data stream, and/or (ii) a frequency at which the data of consecutive elementary data units are received within the particular data stream, based on which the division of the particular specific data stream into elementary data units is at least partially carried out.

The data of the elementary data units may be particularly reliably and efficiently processed on the basis of these pieces of information. The storage size is advantageously the storage space requirements for the data of an elementary data unit of the particular specific data stream. For example, the storage space necessary for a temporary buffering of the data of an elementary data unit of this type (for example, at least for the time period during which the data of an elementary data unit are received, and/or until the received data of an elementary data unit are stored on a storage medium) may be reliably reserved thereby in a precisely fitting manner. The frequency may be, for example, a frequency at which the first byte of data to be stored in consecutive elementary data elements is received in each case within the specific data stream. If an (in particular, at least temporarily constant) data rate of a specific data stream is known, the frequency may be advantageously ascertained on the basis of the storage size and/or, vice versa, the storage size may be ascertained on the basis of the frequency, at least for a time segment.

In addition, the data stream descriptions predefined for the individual specific data streams may each include pieces of information about control data which define, for example, separators, with the aid of which the data of consecutive elementary data units are separated from each other within the particular specific data stream. For example, the division of the particular specific data stream into the elementary data units may be particularly easily and reliably carried out on the basis of these control data. This is additionally discussed in greater detail below.

It may also be provided that the individual data stream descriptions are read out from a separate memory.

An easy and reliable access to the data stream descriptions is made possible thereby. The separate memory may be a remote memory, for example a cloud memory.

It may also be provided that the division of a specific data stream into elementary data units may include grouping the data of the particular specific data stream, based on the data stream description predefined for the particular specific data stream, and thereby obtain the elementary data units.

For example, the particular specific data stream may be analyzed for the presence of the control data defined in the associated data stream description, and/or a division of the particular specific data stream into elementary data units may be carried out on the basis of the control data identified in the particular specific data stream. Consecutive data quantities in the particular specific data stream may be particularly easily and yet reliably identified thereby, based on the control data, and obtained as the individual elementary data units, For example, the particular specific data stream may be divided in each case at the points having the defined control data. The control data do not have to be part of the obtained elementary data units. For example, the control data may define separators (i.e., markings), which, in turn, are advantageously inserted into the specific data stream from the particular source of the specific data stream (in particular, a sensor).

It is also possible to carry out the division of the particular specific data stream into the elementary data units on the basis of the frequency and/or the storage size. The data rate of the particular specific data stream may optionally also be used. For example, the particular specific data stream may be monitored and a new elementary data unit obtained according to the frequency, in each case after the passage of a time period or according to the particular storage size upon reaching a further data throughput.

It may also be provided that an elementary data unit of a specific data stream includes or is made up, in each case, of a group of data of the particular specific data stream.

The group of data of the particular specific data stream is thus a subset of data of the particular specific data stream, This group may be predefined and/or ascertainable by the data stream description of the particular specific data stream. An elementary data unit of a specific data stream may be, for example, a grouping of data of the specific data stream, the grouping preferably being selected on the basis of a technical design of the particular specific data stream, which is stored, for example, in the particular data stream description.

The particular specific data stream may be completely and/or at least partially reconstructed from the data of a specific data stream grouped into the elementary data units, in particular by an arrangement of the individual elementary data elements one after the other. In specific embodiments, it may be necessary for the complete reconstruction of the particular specific data stream to add additional data not contained in the elementary data units, for example the control data already described.

It may also be provided that the data of an elementary data unit of a specific data stream represent a representation of the surroundings of a sensor recorded thereby at a certain point in time and/or during a certain time period.

The “certain time period” may be a time period which is needed to record the data with the aid of the sensor for representing the surroundings. For example, the “certain time period” in the case of a radar sensor may be a time period which is needed to activate multiple radar sensor elements of a radar sensor array of the radar sensor one after the other. In the case of a lidar sensor, for example, the “certain time period” may be a time period which is needed to scan a region of the surroundings with the aid of a laser of the lidar sensor and/or to rotate the laser at least once 360° around a rotation axis.

The data of an elementary data unit may represent a temporal/spatial resolution of sensor data.

It may also be provided that an elementary data unit of a specific data stream in each case includes data of an individual image recorded by a sensor or a row or a pixel of an individual image of this type.

An elementary data unit may be advantageously self-contained thereby, i.e., in particular contain all pieces of information for a snapshot of the surroundings of the sensor.

In particular, an elementary data unit of a specific data stream contains in each case exclusively data of an individual image recorded by a sensor or a row or a pixel of an individual image of this type.

It may also be provided that the distributed storage of the elementary data units of the specific data streams on the at least two storage media is carried out based on a distribution rule.

The distribution rule may advantageously be ascertained on the basis of the data stream descriptions of the specific data streams. This makes it possible to at least implicitly use the properties of the specific data streams known in advance for a distribution of the elementary data units to the individual storage media. After all, as described above, the elementary data units obtained according to a defined scheme advantageously result in a data quantity per time unit, which is in in any case known a priori in advance, at least in principle, and/or having a priori properties, which are in any case known a priori in advance, at least in principle.

Resources for storing the data of the specific data streams may be coordinated in advance thereby, at least partially based on and/or proceeding from the distribution rules. For example, memory areas on the individual storage media for the expected elementary data units to be stored in a distributed manner, and/or bandwidths for write access to the individual storage media may be planned, suitably dimensioned, and/or assigned.

It is particularly advantageous if the distribution rule is ascertained on the basis of a result of an algorithm for solving a “container problem.” Since the elementary data units of the specific data streams occurring per time unit are advantageously already known in advance, the distribution thereof to the storage media may be planned a priori with the aid of an algorithm of this type. Algorithms of this type are well known per se to those skilled in the art, so that they do not need to be discussed in greater detail at this point. Instead, reference may be made to the relevant literature.

The distribution rule may be ascertained entirely or partially in an automated manner, for example on the basis of the data stream descriptions and/or incorporating an algorithm for solving a “container problem.” The automated ascertainment advantageously takes place prior to the data recording and/or at the beginning of the data recording.

The distributed storage of the elementary data units of the specific data streams may be carried out thereby at least partially based on pieces of information known a priori with respect to the specific data streams as well as pieces of information derived therefrom. As a result, a RAID controller used in the conventional manner may be advantageously omitted.

It may also be provided that at least one, preferably exactly one, of the at least two storage media is assigned in each case to each elementary data unit of the specific data streams as the storage location, based on the distribution rule, and the individual elementary data units are preferably stored on the storage medium assigned thereto.

The distribution of the individual elementary data units of the specific data streams may preferably be carried out thereby according to a scheme which is fixed and/or known in advance. As a result, the storage operation is particularly efficient, since no further analysis (in particular of the contents) of the data to be storage is necessary. This time advantage is particularly interesting, especially with regard to a real-time processing.

Due to the distribution rule, the temporally parallel write access to the at least two storage media may also be at least implicitly predefined.

It may also be provided that the elementary data units of at least one, preferably all, of the at least one specific data streams are stored in a distributed manner on multiple of the at least two storage media, in particular according to the stipulation of the distribution rule. The available input bandwidth may be particularly effectively maximized thereby.

It may also be provided that an, in particular, cyclical sequence of storage media is predefined by the distribution rule for at least one, preferably for each, data stream, according to which the elementary data units of the particular specific data stream are stored sequentially on the storage media.

The sequence of storage media thus applies in each case with respect to the elementary data units of the relevant individual specific data stream.

The predefined sequence of storage media is advantageously identical for each of the relevant specific data streams. In specific embodiments, the sequences may also be partially different, in particular, they may at least partially affect a different selection of storage media and/or sequence of storage media.

An (optionally identical) distribution of elementary data units defined for the relevant specific data streams to the at least two storage media may be achieved thereby.

In the case of three existing storage media (S1-S3), the storage could take place for each of the relevant specific data streams whose elementary data units are to be stored sequentially on S1, S2, S3 and again from the beginning, i.e., sequentially on S1, S2, S3, etc. If one is to examine the example of the case that only a single specific data stream is received, three elementary data units of the single specific data stream could always be stored temporally in parallel on the three storage media S1, S2, S3. This again illustrates the possibility of increasing the input bandwidth, in that further storage media are provided.

It may also be provided that an, in particular, cyclical sequence of storage media is predefined by the distribution rule, according to which the elementary data units of the specific data streams are stored sequentially on the storage media.

The sequence of storage media thus applies with respect to the elementary data units of all relevant specific data streams.

For the relevant specific data streams, a distribution of their elementary data units to the at least two storage media may be achieved thereby in each case.

For example, in the case of three existing storage media (S1-S3) and two specific data streams including the elementary data units D1.1, D1.2, D1.3, . . . of the first specific data stream and the elementary data units D2.1, D2.2, D2.3, . . . of the second specific data stream, the temporally consecutive elementary data units D1.1, D2.1, D1.2, D2.2, D1.3, D2.3, . . . could be stored sequentially to S1, S3, S5 and, starting at the beginning again, i.e. sequentially, to S1, S2, S3, etc. Although an elementary data unit of the first specific data stream always occurs here alternately with an elementary data unit of the second specific data stream for purpose of illustration, in specific embodiments the elementary data units of the individual data streams may also occur in a different sequence/at a different frequency (for example, D1.1, D1.2, D2.1, D1.3, D1.4, D2.2, etc. . . . ), depending on when the data of the individual elementary data units are received in each case.

It may also be provided that the distribution rule is ascertained prior to the beginning of the data recording.

As a result, the distributed storage may take place on the basis of rules which are clearly defined a priori. The distribution rule may be particularly easily ascertained based on the data stream descriptions of the individual specific data streams.

It may also be provided that the distribution rule is ascertained in such a way that a maximum data rate permissible in each case for write access to the individual storage media is not exceeded in each case during the distributed storage of the elementary data units of the specific data streams to the at least two storage media.

A particularly efficient storage of the elementary data units may be facilitated thereby.

It may also be provided that the distribution rule is ascertained in such a way that a uniform filling of the individual storage media with data is achieved during the distributed storage of the elementary data units of the specific data streams on the at least two storage media.

In this way, it is possible to avoid the permissible input bandwidth being reduced once the storage media becomes full. In addition, the available memory space may also be used particularly efficiently in this way. A particularly efficient storage of the elementary data units may be facilitated thereby. A storage medium is “filled with data” in that data is stored on the storage medium. A uniform filling of this type may be particularly advantageously achieved by using an algorithm already described above for solving a “container problem.”

It may also be provided that, for each of the at least two storage media, a maximum data rate at which the particular storage medium may be written is known in advance in each case as bandwidth information, and/or a free memory space is known in advance as capacity information, and/or is/are ascertained in an automated manner, the distribution rule preferably being ascertained on the basis of the pieces of bandwidth information and/or pieces of capacity information of the storage media.

A particularly efficient filling of the storage media with the elementary data units may take place thereby.

The automated ascertainment of the bandwidth information and/or the capacity information involves the corresponding pieces of information being requested from the individual storage media.

It may also be provided that the distribution rule is ascertained on the basis of the data stream descriptions predefined for the specific data streams and/or on information on which these data stream descriptions are based, in particular (i) storage sizes of the elementary data units of the particular specific data streams, and/or (ii) frequencies at which the data of consecutive elementary data units within the particular specific data streams are received.

This particularly advantageously makes it possible to incorporate the technical properties of the specific data streams into the distribution.

It is particularly advantageous if the distribution rule is ascertained on the basis of the data stream descriptions predefined for the specific data streams and/or pieces of information on which these data stream descriptions are based, and on the basis of the bandwidth information and/or the capacity information. The technical properties of the specific data streams (sources) as well as the storage media (destinations) may be particularly advantageously incorporated thereby into the distribution.

It may be provided that the identical distribution rule is used for the entire duration of the data recording.

The storage operation may be efficiently carried out thereby.

It may also be provided that the specific data streams (i) each, in particular exclusively, contain data of an application-specific layer, and/or (ii) each do not contain any pieces of protocol and/or transport information.

The application-specific layer is, for example, one of layers 5 through 7 in the OSI model.

The specific data streams thus advantageously do not contain any pieces of information necessary for transferring the data thereof over a transmission channel (for example, pieces of address information of the particular source or the particular destination of the data).

Pieces of information used to assign data of a specific data stream to an elementary data unit (such as the control data described above) can be data of an application-specific layer and/or not as pieces of protocol and/or transport information.

It may also be provided that the specific data streams each represent sensor signals which come, in particular, from imaging sensors and/or from different sensors.

For example, at least one sensor is selected from the group of sensors including: camera sensors, radar sensors, lidar sensors, and/or ultrasonic sensors.

The sensor signals may be, for example, sensor data, in particular sensor raw data.

The specific data streams may thus include, for example, image data from imaging sensors. For this purpose, the sensors may each supply, for example, a continuous and uniform stream of image frames received in each case as a specific data stream.

It may also be provided that at least one specific data stream represents sensor signals of a camera sensor, radar sensor, lidar sensor, and/or ultrasonic sensor.

The sensors may supply time-dependent signals.

It may also be provided that at least one sensor is operated temporally consecutively in different operating modes, and at least one technical specification of the specific data stream received from the sensor, such as (i) a data rate, (ii) a data size of an elementary data unit, and/or (iii) a frequency at which the new elementary data units are received, changes, depending on the operating mode.

For example, the sensor may be initially operated in a first operating mode and be operated in a second operating mode afterwards in time. For example, the resolution of the images recorded by the sensor, and thus the data rate of the specific data stream received by the sensor, may be different in the two operating modes, in particular higher in the second operating mode than in the first operating mode.

For example, an automotive camera sensor may increase the frame rate or the resolution in the presence of a critical traffic situation and thereby switch between the different operating modes.

The time interval within which the operating mode does not change may be stored as separate recordings, each having its own start and end time and its own ID. The fact that the individual intervals belong together may then be flagged on the basis of a higher-level recording ID. They may be thereby joined to form a single, continuous recording, for example during a reconstruction.

It may also be provided that the distribution rule is ascertained in such a way that the elementary data units are stored in a distributed manner on the at least two storage media in each operating mode of the sensor.

The distribution rule is thus advantageously ascertained in such a way that a distributed storage of the elementary data units is ensured regardless of the time-depended selection of the operating modes.

It may also be provided that the data stream description of the specific data stream received from the sensor and/or the distribution rule is/are ascertained in each case at least partially for the operating mode in which the specific data stream received from the sensor has the highest data rate.

As a result, the data recording is, so to speak, aimed at the worst-case scenario and is still possible even in this case. If designed for the worst-case scenario, for example, the memory space reserved for the buffering may be dimensioned to be too large during a time period in which the data rate is lower than the highest data rate. The bandwidth of the write access reserved for storing the elementary data units of the specific data stream may likewise be dimensioned to be too large during a time period in which the data rate is lower than the highest data rate. The memory space on one of the storage media reserved for storing the elementary data units of the specific data stream may likewise be dimensioned to be too large during a time period in which the data rate is lower than the highest data rate. In these cases, however, this is taken into consideration to be able to still reliably carry out a processing of the received data and a distributed storage of the elementary data units during a time period in which the data rate matches the highest data rate.

It may also be provided that it is possible to switch between different data stream descriptions of the specific data stream received from the sensor and/or distribution rules, depending on the selected operating mode of the sensor.

Changed framework conditions may be taken into account flexibly thereby. This permits a particularly efficient handling of resources, in particular of the storage media.

It may also be provided that at least one of the technical specifications of the particular specific data stream is ascertained in an automated manner for at least one specific data stream coming from a sensor by a communication with the sensor and used in the data stream description.

For example, the aforementioned pieces of information of the data stream description may be ascertained in an automated manner thereby and used for ascertaining the data stream description. In addition, reference may be made to the above remarks.

It may also be provided that the elementary data units of at least one specific data stream, preferably of all specific data streams, are each stored in a distributed manner on at least two of the at least two storage media.

A reliable bandwidth of the received specific data streams may be particularly advantageously maximized thereby.

It may also be provided that the elementary data units of at least one specific data stream, preferably of all specific data streams, are each stored in a distributed manner on at least two of the at least two storage media in a non-redundant manner.

This makes it possible to carry out the storage operation particularly efficiently.

It may also be provided that a data rate of at least one data stream of the at least one specific data stream, in particular of all specific data streams received in parallel, has a maximum value which is greater than a maximum permissible data rate at which at least one, preferably all, of the at least two storage media may be written.

Due to the distributed storage (carried out temporally in parallel) of the elementary data units to the at least two storage media, the total bandwidth of the received specific data streams may be greater than the maximum permissible bandwidth during a write access to a single one of the storage media, as was already described above.

For example, each of the storage media may be able to be written at a data rate of no more than 1 Mbit/second in each case. If a single specific data stream is received for data recording, it may theoretically have a bandwidth of 2 Mbits/second, due to the storage distributed in parallel.

The method thus advantageously permits an increase in the input bandwidth, in that one or multiple incoming specific data streams may be stored in a distributed manner to multiple storage media temporally in parallel, preferably in real time.

The data rate of all specific data streams received in parallel can be the sum of the data rates of the individual specific data streams.

It may also be provided that the data recording is carried out in real time and/or does not include a buffering of the data of the received specific data streams in a nonvolatile memory.

If there is no buffering in a nonvolatile memory, the data processing (for example, the grouping of data within a specific data stream to form the elementary data units of the specific data stream) may be carried out particularly rapidly. For example, a buffering may take place in a random-access memory (RAM).

It may also be provided that the data recording involves generating metadata, which include information about the elementary data units stored on the individual storage media, in particular to restore the individual specific data streams from the elementary data units stored in a manner distributed over the at least two storage media.

The metadata may be advantageously used to be able to identify, on the storage media, the elementary data units stored on the individual storage media, retrieve them from the particular storage medium, assign them to a specific data stream, and/or arrange them sequentially in a correct sequence for reconstructing the original specific data stream.

The metadata are advantageously associated with the distribution rule used. The metadata and the distribution rule used may therefore complete each other and provide a common basis for information. A restoration of a specific data stream may be preferably at least partially (preferably completely) possible based on this information basis.

It may also be possible that the metadata contain a selection of the following pieces of information: pieces of information about the data recording, such as a unique identifier for the data recording and/or a unique identifier for the system used for the data recording; memory address areas of the individual elementary data units, in particular, pointers to the first and last byte of the particular elementary data units; unique identifiers for identifying individual elementary data units; assignments of the individual elementary data units to sources, in particular sensors; pieces of information about the temporal sorting of the elementary data units, for example in the form of time stamps, one or multiple lists of the unique identifiers in a chronological sequence; a unique identifier for the data recording session; unique identifiers for the storage media participating in the data recording; unique identifiers for tags arranged on the storage media; a list of sources where the specific data streams originate; a list of the storage media participating in the data recording, in particular to check whether the recorded data are completely present; name and path of a destination file in which the data of reconstructed data streams are to be stored; and/or start and end points in time of the data recording.

The tags may be, for example, RFID tags. The presence of the storage media may be captured thereby in a radio-based manner. For this purpose, the individual storage media may each be equipped with a tag of this type. Each tag may contain a unique identifier for the particular storage medium, which may be obtained by reading out the tag, in particular in a radio-based manner.

The metadata can include pieces of information about the operating modes of one or multiple sensors present during the data recording. As a result, it is known when which data stream descriptions and/or distribution rules are used. The metadata may include pieces of information about the data stream descriptions and/or distribution rules used in a time-dependent manner during the data recording.

It may also be provided that the metadata are stored in each case completely on at least one, preferably on all, of the at least two storage media and/or in a separate memory.

If the metadata are stored together with the rest of the elementary data units on one or multiple storage media, a reliable reconstruction of the data is possible.

The separate memory may be a remote memory, for example a cloud memory.

It may also be provided that only metadata are stored on each storage medium for the elementary data units which are stored on the particular storage medium.

To reconstruct the data, the metadata may then be first retrieved from all participating storage media and evaluated. The reconstruction may subsequently be advantageously carried out on the basis of the collected metadata.

It may also be provided that metadata for all elementary data units are stored on each storage medium.

As a result, the storage media necessary for a reconstruction may be advantageously known. Any missing storage media may be quickly determined thereby for a reconstruction.

The object is achieved by the invention according to a second aspect by means of a method for generating at least one data stream, in particular by a method according to the first aspect of the invention, from elementary data units stored in a manner distributed over at least two storage media or source files, at least two elementary data units being retrieved from different storage media or from different source files based on metadata and arranged in a chronological sequence, and the at least one data stream being at least partially generated thereby.

A data stream may be advantageously reconstructed thereby from the data stored fragmentally and in a manner distributed over multiple storage media or source files. Due to the interplay between the stored metadata and the stored elementary data units, no additional prior knowledge of the original data streams or other circumstances is advantageously necessary during the data recording. This makes a reconstruction particularly reliably possible.

Due to the possibility of also generating the data stream from source files, an independence of storage media is advantageously given. For example, the data stored on the at least two storage media during the course of a data recording, using a method according to the first aspect of the invention, may therefore be transferred in the form of files (in particular, the contents of a storage medium as a separate file) to a remote computer (for example to a cloud computer), where the data stream is generated as described from the transferred source files. The generated data stream may subsequently be optionally transferred back. In specific embodiments, the source files may be transferred from different entities to the remote computer, and/or the generation of the data stream may be started only when all necessary data files are present. With the aid of the pieces of information stored in the metadata, it is possible to check for the presence of all source files, for example for the presence of all storage media, which is discussed in greater detail below.

The generated data stream may be a data stream including the data of a sensor (such as a radar, lidar, or camera sensor). For example, the data stream may be a previously received data stream (for example, a specific data stream received in a method according to the first aspect of the invention).

All features which have been described in reference to the method according to the first aspect of the invention may also be advantageously provided in a corresponding, in particular mirror-image, manner in the method according to the second aspect of the invention, unless otherwise apparent from the context.

It may also be provided that the data of the generated data stream are transferred over a network and/or stored in a separate memory.

The separate memory may be a remote memory, for example a cloud memory.

It may also be provided that at least two data streams made up of at least two elementary data units are at least partially generated on the basis of the metadata, each of the generated data streams preferably being stored in a separate destination file or at least two of the generated data streams being stored in a common file.

Generated data streams may be particularly advantageously stored in the particular file, in that the data thereof are stored in the file.

It may also be provided that the metadata are retrieved from at least one storage medium or from at least one source file, from which at least one of the elementary data units is also retrieved.

It may also be provided that a check is made on the basis of the metadata as to whether all of the at least two storage media or all of the at least two source files are available, in particular, for retrieving the elementary data units stored thereon or therein.

For example, pieces of information about the tags provided on the individual storage media may be contained in the metadata for this purpose. A check can then be made for the presence of the individual tags and thus for the presence of the individual storage media. A unique identifier may likewise be contained in each of the source files, so that a check made be made for the presence of all source files with the aid of the metadata containing the identifiers of all source files. In the case that at least one storage medium or at least one source file is detected as being not present, an error signal may be generated and the generation of the data stream may be optionally aborted.

The object is achieved by the invention according to a third aspect by means of an apparatus for data processing, in particular for recording data, which is data-linked or data-linkable to one or multiple sensors, and/or which is data-linked or data-linkable to at least two storage media, the apparatus including components which are configured to carry out a method according to the first aspect of the invention.

All advantages described in reference to the method according to the first aspect of the invention also apply correspondingly to the apparatus. Reference may therefore be made at this point to the previous remarks.

The features described in relation to the method according to the first aspect of the invention may also be provided correspondingly in the case of the apparatus or in connection with the apparatus, individually and in any combination, unless otherwise apparent from the context. In particular, the apparatus may be configured to carry out the method steps described in reference to the method according to the first aspect of the invention, in particular individually and in any combination.

The apparatus can include one or multiple interfaces, via which the data link to the sensor or the sensors is established or may be established. The apparatus preferably includes one or multiple interfaces, via which the data link to the storage media is established or may be established.

The apparatus may include a memory, a processor, a receiving device, a transmitting device, or any combination thereof. The apparatus may provide and/or make available and/or include everything that is presented thereby, such as, in particular, all necessary resources, for example in the form of software and/or hardware resources. The apparatus may advantageously include electrical components for receiving, transmitting, storing, processing, evaluating, and/or analyzing the data of the particular specific data streams.

The apparatus may be designed as a data logger. The apparatus may represent a distributed system.

The object is achieved by the invention according to a fourth aspect, in which an apparatus for data processing is proposed, in particular for reconstructing a data stream recorded, in particular, with the aid of an apparatus according to the third aspect of the invention, which is data-linked or data-linkable to at least two storage media, the apparatus including components which are configured to carry out a method according to the second aspect of the invention.

All advantages described in reference to the method according to the second aspect of the invention also apply correspondingly to the apparatus according to the fourth aspect of the invention. Reference may therefore be made at this point to the previous remarks.

The features described in reference to the method according to the second aspect of the invention may also be provided correspondingly in the case of the apparatus or in connection with the apparatus, individually and in any combination, unless otherwise apparent from the context. In particular, the apparatus may be configured to carry out the method steps described in reference to the method according to the second aspect of the invention, in particular individually and in any combination.

The apparatus preferably includes one or multiple interfaces, via which the data link to the storage media is established or may be established.

The apparatus may include a memory, a processor, a receiving device, a transmitting device, or any combination thereof. The apparatus may provide and/or make available and/or include everything that is presented thereby, such as, in particular, all necessary resources, for example in the form of software and/or hardware resources. The apparatus may advantageously include electrical components for transmitting the particular data stream (for example, to another entity).

The apparatus for data processing may be, for example, a cloud computer. The apparatus for data processing may represent a distributed system. For example, parts of the apparatus for data processing may be provided in the cloud.

The apparatus for data processing according to the third aspect of the invention and the apparatus for data processing according to the fourth aspect of the invention can be a unified apparatus for data processing.

The object is achieved by the invention according to a fifth aspect, in that a computer program product is proposed, which comprises commands, which, when the program is executed by an apparatus for data processing, in particular the apparatus for data processing according to the third aspect of the invention and/or according to the fourth aspect of the invention, prompt the latter to carry out a method according to the first aspect of the invention and/or according to the second aspect of the invention.

The computer program product may be designed, for example, as a file, which is stored or may be stored on a computer-readable medium.

The object is achieved by the invention according to a sixth aspect, in that a signal sequence is proposed, which may be transmitted, in particular, over a computer network, the signal sequence representing data of a data stream received in a method according to the first aspect of the invention and/or a data stream generated in a method according to the second aspect of the invention.

Due to the signal sequence, the data of the particular data stream may be advantageously exchanged between different users.

For example, the signal sequence may be receivable by a remote computer and/or transmittable to a remote computer.

The object is achieved by the invention according to a seventh aspect, in that a storage medium is proposed, in particular for use in a method according to the second aspect of the invention and/or in an apparatus according to the fourth aspect of the invention, at least some data of at least one data stream being stored on the storage medium, in particular in multiple memory areas of the storage medium which do not have a cohesive address space, metadata being stored on the storage medium, the metadata specifying the memory areas of the storage medium, in which data of the data stream are stored.

The data of a data stream stored in a fragmented manner may therefore be completely or partially reconstructed to form the data stream on the basis of the meta data as functional data.

All advantages described in reference to the method according to the second aspect of the invention also apply correspondingly to the storage medium according to the seventh aspect of the invention. Reference may therefore be made at this point to the previous remarks.

The at least two storage media data-linked to the apparatus for data processing according to the fourth aspect of the invention, and/or the at least two storage media used in a method according to the second aspect of the invention may each be a storage medium according to the seventh aspect of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an apparatus for data processing according to the third aspect of the invention, including data-linked sensors and storage media;

FIG. 2 shows a schematic representation of data streams received from the sensors in FIG. 1;

FIG. 3 shows a schematic representation of the storage media from FIG. 1, including elementary data units of the elementary data streams stored thereon as well as parts of the data streams;

FIG. 4 shows a schematic representation of a file including metadata;

FIG. 5 shows a schematic representation of an apparatus for data processing according to the fourth aspect of the invention, including data-linked storage media;

FIG. 6 shows a flowchart of a method according to the first aspect of the invention; and

FIG. 7 shows a flowchart of a method according to the second aspect of the invention.

### DETAILED DESCRIPTION

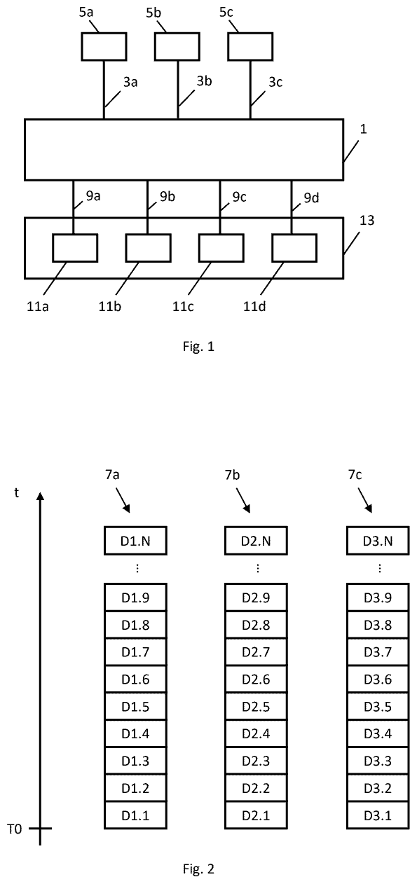

FIG. 1 shows a schematic representation of an apparatus for data processing 1 according to the third aspect of the invention.

Apparatus for data processing 1 is data-linked to three sensors 5a through 5c via data lines 3a through 3c. Sensors 5a through 5c may be sensors of a vehicle. Sensors 5a through 5c may each generate sensor data, which may be received by apparatus for data processing 1 via data lines 3a through 3c.

Apparatus for data processing 1 continuously receives a specific data stream including sensor data from sensor 5a via data line 3a. Sensor 5a is, for example, a camera sensor. The camera sensor may record images of its surroundings, for example, at a certain image refresh rate (frame rate). The specific data stream in this case then contains the data from individual images of the camera sensor recorded consecutively in time.

Apparatus for data processing 1 continuously receives a specific data stream including sensor data from sensor 5b via data line 3b. Sensor 5b is, for example, a radar sensor. The radar sensor may include, for example, a plurality of pairs of transmitter and receiver antennas and record images of its surroundings at a certain recording rate. The transmitted sensor data may be, for example, the images of a representation of the surroundings in local space reconstructed by sensor 5b from the sensor raw data. Alternatively, only the sensor raw data (which are present, for example, in Fourier space) may be transmitted.

Apparatus for data processing 1 continuously receives a specific data stream including sensor data from sensor 5c via data line 3c. Sensor 5c is, for example, a lidar sensor. The lidar sensor may record images of its surroundings, for example, at a certain image refresh rate (frame rate). For this purpose, a laser of the lidar sensor may scan its surroundings. The specific data stream in this case contains the data from individual images of the lidar sensor recorded consecutively in time.

In specific embodiments, apparatus for data recording 1 could also be data-linked to more or to fewer sensors.

FIG. 2 shows a schematic representation of the specific data streams received from sensors 5a through 5c.

Apparatus for data processing 1 receives specific data stream 7a from sensor 5a. Specific data stream 7a received from sensor 5a are known in advance with regard to certain technical properties. These properties are stored in a data stream description generated in advance for specific data stream 7a. For the camera sensor mentioned as an example, the technical properties of specific data stream 7a stored in the data stream description could be the frame rate and the storage size of a frame. Each such group of data of a frame may be handled as an elementary data unit. The data of consecutive frames (i.e., elementary data units) are recognizable, separated logically from each other, in data stream 7a, due to control data contained in specific data stream 7a. For example, the beginning and/or the end of a data quantity belonging to an elementary data unit may be marked by the control data (the particular sensor could, for example, insert corresponding markings into the data stream on its own accord). Pieces of information about these control data are advantageously stored in the data stream description of specific data stream 7a. Specific data stream 7a is illustrated in FIG. 2 as temporally consecutive elementary data units D1.1 through D1.N. First elementary data unit D1.1 of specific data stream 7a is received at point in time T0, while the further elementary data units D1.2 through D1.N are received subsequently in time according to the inverses of the frame rate. Each elementary data unit D1.1 through D1.N, in turn, can be constructed from multiple data, for example the values of the individual pixels of a recorded image frame.

Apparatus for data processing 1 likewise receives specific data stream 7b from sensor 5b and specific data stream 7c from sensor 5c. Specific data streams 7b and 7c are also each known in advance with respect to certain technical properties. These properties are stored in a data stream description generated in each case in advance for particular specific data streams 7b and 7c. For the radar and lidar sensors mentioned as examples, the technical properties of particular specific data stream 7b or 7c stored in the particular data stream description could be the frame rate and the storage size of a frame of a radar or lidar recording. Each such group of data of a frame may also be referred to as an elementary data unit. Specific data streams 7b and 7c are therefore also each illustrated in FIG. 2 as temporally consecutive elementary data units D2.1 through D2.N and D3.1 through D3.N, respectively. First elementary data unit D2.1 of specific data stream 7b and first elementary data unit D3.1 of specific data stream 7c are each received at point in time T0, while the further elementary data units D2.2 through D2.N and D3.2 through D3.N are received subsequently in time according to the inverses of the frame rate. In this case as well, each elementary data unit D2.1 through D2.N and D3.1 through D3.N in turn, are constructed from multiple data, for example the values of the individual pixels of a recorded image frame.

The elementary data units of a specific data stream 7a through 7c illustrated farther up along positive time axis t in FIG. 2 are received at a later point in time than elementary data units of particular specific data streams 7a through 7c illustrated farther down. Specifically, within specific data stream 7a, for example, elementary data unit D1.1 is received temporally before elementary data unit D1.2, and the latter is received temporally before elementary data unit D1.3, etc.

Specific data streams 7a through 7c are received from sensors 5a through 5c temporally in parallel. The elementary data units of the different sensors 5a through 5c are therefore also received temporally in parallel. In the case illustrated in FIG. 2, all nth (n=1 . . . N) elementary data units of the three specific data streams 7a through 7c are each received temporally in parallel. This means that all first elementary data units D1.1, D2.1, and D3.1 are received temporally in parallel, all second elementary data units D1.2, D2.2, and D3.2 are received temporally in parallel, etc. In the present case, this special case is selected only for the reasons of better representability. The nth elementary data units of different specific data streams may generally be received arbitrarily offset from each other. The temporal offset of elementary data units of the same number n (for example, D1.4 and D2.4) of two specific data streams depends, in particular, on what data quantity is contained within an elementary data unit in each case, and at what data rate the data are received from the particular sensors by apparatus for data processing 1 via the data lines. In the special case illustrated in FIG. 2, it is assumed that the data quantity of each

elementary data is transmitted from the particular sensor to the apparatus for data processing within the same time for each sensor 5a through 5c. Moreover, the number of elementary data units N of individual specific data streams 7a through 7c may be different.

For example, the sensor data are generated by sensors 5a through 5c during a test drive with the vehicle mentioned at the outset for the purpose of subsequently using them for a data-driven development of applications for driver assistance systems and autonomous driving. To do this, the specific data streams must be stored during the test drive.

Apparatus for data processing 1 (FIG. 1) is data-linked for this purpose to four storage media 11a through 11d of a storage unit 13 via four data lines 9a through 9d. The data received by the three sensors 5a through 5c may be stored on these storage media 11a through 11d.

Apparatus for data processing 1 divides each specific data stream 7a through 7c into elementary data units D1.n, D2.n, and D3.n (n=1 . . . N), which were already described above in reference to FIG. 2. The division of specific data stream 7a into elementary data units D1.n thus takes place on the basis of the data stream description generated for specific data stream 7a (in particular, by dividing specific data stream 7a at the points where a marking is detected, which is stored as an item of control data in the data stream description). The division of specific data stream 7b into elementary data units D2.n thus takes place on the basis of the data stream description generated for specific data stream 7b (in particular, by dividing specific data stream 7b at the points where a marking is detected, which is stored as an item of control data in the data stream description). The division of specific data stream 7c into elementary data units D3.n thus takes place on the basis of the data stream description generated for specific data stream 7c (in particular, by dividing specific data stream 7c at the points where a marking is detected, which is stored as an item of control data in the data stream description). The division of a data stream 7a through 7c into elementary data units D1.n, D2.n, and D3.n thus means in this case the groupings of data of particular data stream 7a through 7c to thereby obtain the individual elementary data units. Each elementary data unit obtained in this way may advantageously correspond directly to the data of a frame of particular sensor 5a through 5c (for example, of the camera sensor, of the radar sensor, or of the lidar sensor).

To be able to carry out the division of individual specific data streams 7a through 7c into the elementary data units on the basis of the particular control data, specific data streams 7a through 7c may, for example, be analyzed continuously with a view toward a corresponding marking. In specific embodiments, the data of a specific data stream 7a through 7c may also be grouped into the individual data units on the basis of the frequency or storage size of a data frame indicated in the particular data stream description.

The data of individual elementary data units D1.n, D2.n, and D3.n of specific data streams 7a through 7c are buffered in each case in a volatile RAM memory, before they are finally stored. The storage size to be reserved for elementary data units D1.n, D2.n, and D3.n of specific data streams 7a through 7c may be specified in advance on the basis of the data stream description, and the use of resources may thus be optimized.

Individual elementary data units D1.n, D2.n, and D3.n of specific data streams 7a through 7c are stored in a manner distributed over the four storage media 11a through 11d. Apparatus for data processing 1 carries out the distributed storage according to a distribution rule. This distribution rule is generated on the basis of the three data stream descriptions present for specific data streams 7a through 7c (cf. remarks above) prior to starting the data recording. As a result, the distribution of the elementary data units to individual storage media 11a through 11d may take place, for example, depending on the data size of the different elementary data units D1.n, D2.n, and D3.n.

Although the nth elementary data units of the three specific data streams 7a through 7c are all received temporally in parallel in each case in the present exemplary embodiment, they may nevertheless have different data quantities (for example, the temporally parallel receipt of the nth data unit in each case still taking place on data lines 3a through 3c, due to different data rates) and thus require a different amount of storage apace on storage media 11a through 11d and a different write access duration for storage media 11a through 11d.

In the present case, the distribution rule specifies a cyclical sequence, according to which elementary data units D1.n, D2.n, and D3.n of specific data streams 7a through 7c are stored on individual storage media 11a through 11d. For example, without any loss of generality, storage medium 11a, then storage medium 11b, then storage medium 11c, then storage medium 11d, then again storage medium 11a, etc. are assigned sequentially to the elementary data units. In the present case, the distribution rule additionally specifies that, in the case of elementary data units of different specific data streams 7a through 7c arriving temporally in parallel, the elementary data unit of specific data stream 7a is assigned to a storage medium first, then the elementary data unit of specific data stream 7b is assigned to a storage medium, and then the elementary data unit of specific data stream 7c is assigned to a storage medium.

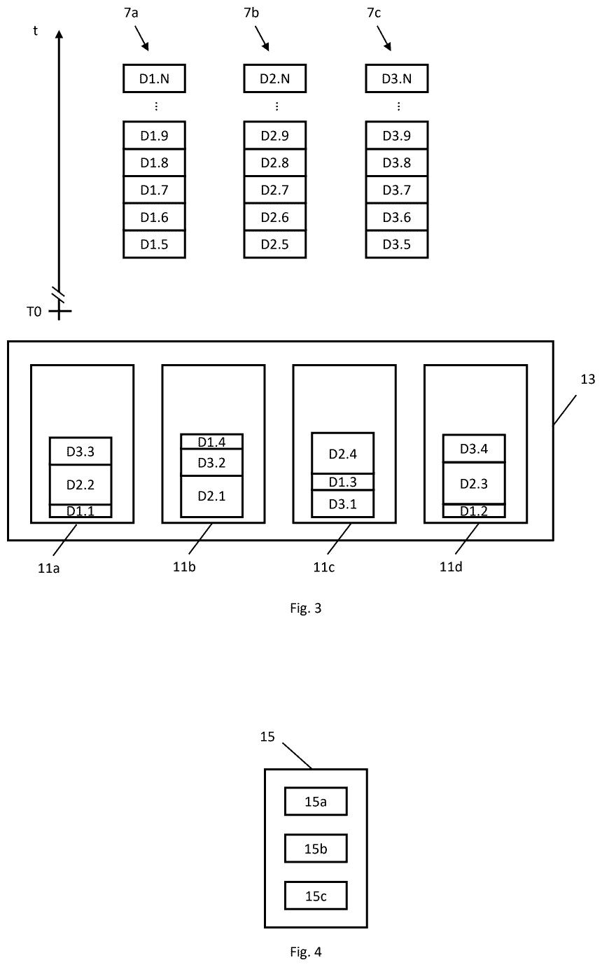

FIG. 3 shows a schematic representation of storage media 11a through 11d from FIG. 1, including elementary data units of data streams 7a through 7c stored thereon as well as parts of data streams 7a through 7c.

At the point in time illustrated in FIG. 3, elementary data units D1.1 through D1.4 of specific data stream 7a, elementary data units D2.1 through D2.4 of specific data stream 7b, and elementary data units D3.1 through D3.4 of specific data stream 7c were already stored in a manner distributed over four storage media 11a through 11d. The elementary data units already stored are therefore no longer shown in FIG. 3 as part of specific data streams 7a through 7c.

Using the distribution rule (storage location of elementary data units arriving cyclically on storage media 11a-11b-11c-11d, for elementary data units of different specific data streams arriving temporally in parallel, those of specific data stream 7a are given a higher priority than those of specific data stream 7b, and the latter are given a higher priority than those of specific data stream 7c), the following result:
storage medium 11a is occupied by elementary data units D1.1 of specific data stream 7a, D2.2 of specific data stream 7b, and D3.3 of specific data stream 7c;
storage medium 11b is occupied by elementary data units D2.1 of specific data stream 7b, D3.2 of specific data stream 7c, and D1.4 of specific data stream 7a;
storage medium 11b is occupied by elementary data units D3.1 of specific data stream 7c, D1.3 of specific data stream 7a, and D2.4 of specific data stream 7b;
storage medium 11d is occupied by elementary data units D1.2 of specific data stream 7a, D2.3 of specific data stream 7b, and D3.4 of specific data stream 7c.

The storage of the different elementary data units on individual storage media 11a through 11d takes place by a temporally parallel write access to storage media 11a through 11d. For example, elementary data units D1.1, D2.1, D3.1, and D1.2 are stored temporally in parallel, in any case to the extent that the individual data are already present. Due to the parallel writing of storage media 11a through 11d, the permissible total input bandwidth may be increased, i.e., the sum of the bandwidths of individual specific data streams 11a through 11c.

In the following step, the next elementary data units, to the extent they have already been received or will be received later on, are stored on the storage media according to the distribution rule.

At the bottom of FIG. 3, the different storage sizes (and thus the data quantity) of the elementary data units of the three specific data streams 7a through 7c are shown by the different heights of the schematically illustrated elementary data units (stored on storage media 11a through 11d). The storage size of an elementary data unit D2.n of specific data stream 7b is therefore greater than the storage size of an elementary data unit D3.n of specific data stream 7c, which is greater than the storage size of an elementary data unit D1.n of specific data stream 7a. The storage size of individual elementary data units D1.n, D2.n, and D3.n of an individual specific data stream 7a through 7c are, however, identical in the present case.

The distribution rule was ascertained in such a way that it results in the most uniform possible filling of individual storage media 11a through 11d with the elementary data units. For this purpose, algorithms for solving a “container problem” may also be used to generate the distribution rule. Moreover, the distribution rule ensures that the particular maximum bandwidth of storage media 11a through 11c is not exceeded during the write access thereto. Since the data quantity to be expected (and thus the number of elementary data units) per time unit and per specific data stream is at least partially known in advance, based on the individual data stream descriptions, the distribution rule may be generated in such a way that the most efficient possible distributed storage of the elementary data units is carried out. Due to the distribution rule, the maximum permissible bandwidths (during write access) of individual storage media 11a through 11d may be taken into account, as can the necessary storage quantity per elementary data unit for the different specific data streams, it being thus possible to optimize the storage operation.

The data of specific data streams 7a through 7c may be stored in real time even with a high total bandwidth, due to the described division of specific data streams 7a through 7c into elementary data units, based on the data stream descriptions as well as the distributed storage of the elementary data units on storage media 11a through 11d, based on the distribution rule. After all, the maximum permissible bandwidth of individual storage media 11a through 11d is advantageously available in total in each case, due to the division into elementary data units and the temporally parallel writing of storage media 11a through 11d. Input data may thus be advantageously stored at a total bandwidth which is scaled with the individual bandwidths of storage media 11a through 11d.

The storage size of the individual elementary data units of an individual specific data stream 7a through 7c is assumed to be identical, as mentioned. In specific embodiments, the storage size of the individual elementary data units of at least one specific data stream 7a through 7c may, however, also vary depending on time. This may occur, for example, when one of sensors 5a through 5c is operated in different operating modes depending on time, and the data quantity of an elementary data unit or the time interval between the elementary data units of the particular specific data stream varies thereby depending on time. For example, the camera sensor (sensor 5a) may be initially operated sequentially in time in a normal mode having a first resolution and subsequently in an alarm mode having a second resolution which is higher than the first resolution. For this purpose, the data stream description and/or the distribution rule could be aimed at the operating mode having the highest data rate (worst case). The fact that the reserved resources are not fully exhausted during one operating mode may possibly be taken into consideration (in the example, therefore, during normal mode). Alternatively, a different data stream description and/or distribution rule could also be selected and used, depending on the operating mode. A use of resources which is optimized for each operating mode could be made possible thereby.

In any case, after all elementary data units of all specific data streams 7a through 7c have been stored on storage media 11a through 11d, a file 15 containing metadata is stored on each storage medium 11a through 11d.

FIG. 4 shows a schematic representation of file 15.

Pieces of information about participating storage media 11a through 11d are contained in a first metadata area 15a of file 15. For example, a unique identifier of each storage medium 11a through 11d may be stored for this purpose in metadata area 15a.

Pieces of information about the elementary data units stored on particular storage medium 11a through 11d, on which file 15 is stored, may be contained in a second metadata area 15b of file 15. For example, number n of the elementary data unit within the specific data stream and/or a start and/or end address of a memory area, within which the data of the elementary data unit are stored on the particular storage medium, may be stored for this purpose for each elementary data unit of the specific data stream which is stored on the particular storage medium and whose data is partially contained by the particular elementary data unit.

Pieces of information about the data recording are stored in a third metadata area 15c of file 15, for example a time stamp in reference to the start of the data recording and a time stamp in reference to the end of the data recording.

With the aid of apparatus for data processing 1 (as well as with the aid of the described method executed thereby) a storage of data streams of even a high bandwidth on multiple storage media may therefore be carried out efficiently. As a result, the necessary bandwidth for a simultaneous recording of multiple data streams from different sensors may be provided even during a test drive. This is highly advantageous for a data-driven development of applications for driver assistance systems and autonomous driving.

The data of individual specific data streams 7a through 7c stored in a distributed manner on storage media 11a through 11d may, for example, be used later on to train a neural network. For this purpose, the individual specific data streams must be reconstructed from the elementary data units stored in a distributed manner.

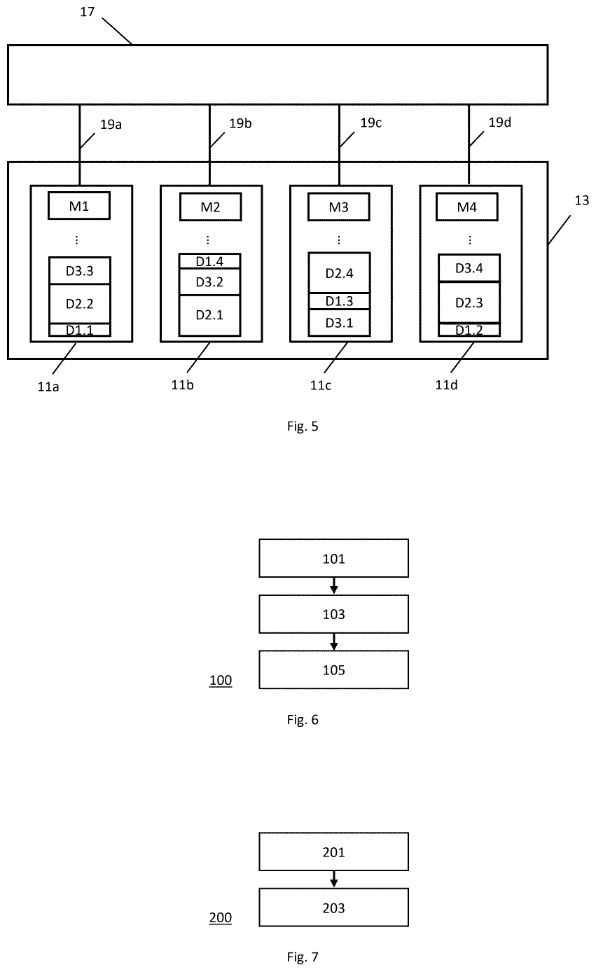

FIG. 5 shows a schematic representation of an apparatus for data processing 17 according to the fourth aspect of the invention. Apparatus for data processing 17 may be used to reconstruct original specific data streams 7a through 7c.

For this purpose, apparatus for data processing 17 is data-linked to the four storage media 11a through 11d of storage unit 13 (which were previously linked to apparatus for data processing 1) via four data lines 19a through 19d. For example, storage unit 13 may be transferred for this purpose from a location of apparatus for data processing 1 to a different location of apparatus for data processing 17.

In contrast to the situation illustrated above in reference to the one illustrated in the lower part of FIG. 3, all elementary data units D1.n, D2.n, and D3.n of all specific data streams 7a through 7c are now stored on storage media 11a through 11d (even if only the elementary data units already sketched in the lower part of FIG. 3 are also illustrated in FIG. 5, but not the other elementary data units from the upper part of FIG. 3). A file M1 through M4 containing metadata is also stored on each storage medium 11a through 11d. Each file may have the same structure as file 15 described in reference to FIG. 4 and contain the corresponding pieces of information. While the pieces of information in the first and third metadata areas are each identical in the four files M1 through M4m the pieces of information about the elementary data units stored in the particular second metadata area vary from storage medium to storage medium.

The metadata from files M1 through M4 are first evaluated for a reconstruction of the original data streams (specific data streams 7a through 7c). The presence of all four storage media 11a through 11d may be checked and confirmed on the basis of the (identical) pieces of information in the first metadata area of each file M1 through M4. For each elementary data unit D1.n of specific data stream 7a, storage medium 11a through 11d as well as the start and end address of the memory area of the relevant storage medium, in which the data thereof are stored, may be ascertained on the basis of the piece of information from the second metadata area of all four files M1 through M4. Specific data stream 7a may be reconstructed by reading the data of individual elementary data units D1.n from the particular memory area and placing them in the right sequence n=1 . . . N. An identical procedure for each elementary data unit D2.n of specific data stream 7b and for each elementary data unit D3.n of specific data stream 11c permits a reconstruction of specific data streams 7b and 7c. The reconstructed data streams may be stored, for example, on a data carrier or transferred via a computer network, such as the Internet, for further use.

In specific embodiments, apparatus for data processing 17 may be identical to apparatus for data processing 1.

The data of received and reconstructed specific data streams 7a through 7c may each be a signal sequence according to the sixth aspect of the invention.

Storage media 11a through 11d described in reference to FIG. 5 may each be a storage medium according to the seventh aspect of the invention.

FIG. 6 shows a flowchart 100 of a method according to the first aspect of the invention.

The method may be used to carry out a data recording, for example a data recording as described above in reference to FIGS. 1 through 4.

In 101, at least one data stream is received for the purpose of recording its data, at least one specific data stream being included therein.

In 103, each specific data stream is divided into elementary data units, based on a data stream description predefined for the particular specific data stream.

In 105, the elementary data units of all specific data streams are stored in a distributed manner on at least two storage media.

For example the distributed storage of the elementary data units of the specific data streams on the at least two storage media may be carried out in 105, based on a distribution rule. At least one and/or preferably exactly one of the at least two storage media may be assigned in each case to each elementary data unit of the specific data streams as the storage location, based on the distribution rule, and the individual elementary data units may be stored on the storage medium assigned thereto in each case.

The method may be carried out, for example, by apparatus for data processing 1 described in reference to FIG. 1, which may be configured accordingly for this purpose.

FIG. 7 shows a flowchart 200 of a method according to the second aspect of the invention.

The method may be used to generate at least one data stream made up of elementary data units stored in a manner distributed over at least two storage media or source files, in particular using the method according to the first aspect of the invention. This may be a reconstruction as described, for example, above in reference to FIG. 5.

In 201, at least two elementary data units are retrieved from different storage media or from different source files on the basis of metadata.

In 203, the at least two elementary data units are placed in a chronological sequence, and the at least one data stream is at least partially generated thereby.

The method may be carried out, for example, by apparatus for data processing 17 described in reference to FIG. 5, which may be configured accordingly for this purpose.

The features disclosed in the above description, in the drawings and in the claims may be essential to the invention in its various specific embodiments, both individually and in any combination.

What is claimed is:

1. A method for carrying out a data recording, the method comprising:
receiving at least one data stream for recording the data thereof, at least one specific data stream being included therein;
dividing each specific data stream into elementary data units, based on a data stream description predefined for the particular specific data stream; and
storing the elementary data units of all specific data streams in a distributed manner on at least two storage media, the distributed storage of the elementary data units of the specific data streams to the at least two storage media being carried out on the basis of a distribution rule;
assigning at least one and/or exactly one of the at least two storage media to each elementary data unit of the specific data streams as the storage location, based on the distribution rule; and
storing the individual elementary data units on the storage medium assigned thereto.

2. The method according to claim 1, wherein the specific data streams are each received continuously and are divided into elementary data units, and/or two or more than two data streams are received, and two or more than two specific data streams are included therein, which are at least partially received temporally in parallel.

3. The method according to claim 1, wherein
(a) the data stream descriptions predefined for the individual specific data streams each include one or multiple technical specifications of the particular specific data stream, based on which the division of the particular data stream into elementary data units is at least partially carried out;
(b) the data stream descriptions predefined for the individual specific data streams each include pieces of information about (i) a storage size of an elementary data unit of the particular specific data stream, and/or (ii) a frequency at which the data of consecutive elementary data units are received within the particular data stream, based on which the division of the particular specific data stream into elementary data units is at least partially carried out; and/or
(c) the division of a specific data stream into elementary data units includes grouping the data of the particular specific data stream, based on the data stream description predefined for the particular specific data stream, and thereby obtaining the elementary data units.

4. The method according to claim 1, wherein an elementary data unit of a specific data stream contains data of an individual image recorded by a sensor or a row or a pixel of an individual image of this type.

5. The method according to claim 1, wherein the elementary data units of at least one or all of the at least one specific data stream(s) is/are stored in a distributed manner on multiple of the at least two storage media according to the distribution rule, and/or wherein a cyclical sequence of storage media is predefined by the distribution rule for at least one or for each specific data stream according to which the elementary data units of the particular specific data stream are stored sequentially on the storage media.

6. The method according to claim 1, wherein:
(i) the distribution rule is ascertained in such a way that a maximum data rate permissible in each case for the write access to the individual storage media is not exceeded in each case during the distributed storage of the elementary data units of the specific data streams on the at least two storage media;
(ii) the distribution rule is ascertained in such a way that a uniform filling of the individual storage media with data is achieved during the distributed storage of the elementary data units of the specific data streams on the at least two storage media; and/or
(iii) for each of the at least two storage media, a maximum data rate at which the particular storage medium may be written is known in advance in each case as bandwidth information and/or a free memory space is known in advance as capacity information, and/or is/are ascertained in an automated manner, the distribution rule being ascertained on the basis of the pieces of bandwidth information and/or pieces of capacity information of the storage media.

7. The method according to claim 1, wherein the specific data streams each represent sensor signals which come from imaging sensors and/or from different sensors; wherein:
(a) at least one specific data stream represents sensor signals of a camera sensor, radar sensor, lidar sensor, and/or ultrasonic sensor, and/or
(b) at least one sensor is operated temporally sequentially in different operating modes, and at least one technical specification of the specific data stream received from the sensor changes, depending on the operating mode, which includes (i) a data rate, (ii) a data size of an elementary data unit, and/or (iii) a frequency at which new elementary data units are received, and
wherein the distribution rule is ascertained in such a way that the elementary data units are stored in a distributed manner on the at least two storage media in each operating mode of the sensor.

8. The method according to claim 1, wherein the data stream description of the specific data stream received from the sensor and/or the distribution rule is/are ascertained in each case at least partially for the operating mode in which the specific data stream received from the sensor has the highest data rate.

9. The method according to claim 1, wherein a switch between different data stream descriptions of the specific data stream received from the sensor and/or distribution rules takes place, depending on the selected operating mode of the sensor.

10. The method according to claim 1, wherein the elementary data units of at least one specific data stream, preferably of all specific data streams, are each stored in a distributed manner on at least two of the at least two storage media in a non-redundant manner.

11. The method according to claim 1, wherein the data recording is carried out in real time and/or does not include a buffering of the data of the received specific data streams in a nonvolatile memory.

12. The method according to claim 1, wherein the data recording includes generating metadata, which include pieces of information about the elementary data units stored on the individual storage media for restoring the individual specific data streams from the elementary data units stored in a manner distributed over the at least two storage media, and wherein the metadata contain a selection of the following pieces of information:
pieces of information on the data recording, such as a unique identifier for the data recording and/or a unique identifier for the system used for the data recording;
memory address areas of the individual elementary data units or pointers to the first and the last byte of the particular elementary data units;
unique identifiers to identify individual elementary data units;
assignments of the individual elementary data units to sources or sensors;
pieces of information about the temporal sorting of the elementary data units in the form of time stamps, or one or multiple lists of the unique identifiers in a chronological sequence;
a unique identifier for the data recording session;
unique identifiers for the storage media participating in the data recording;
unique identifiers for tags arranged on the storage media;
a list of sources where the specific data streams originated;
a list of the storage media participating in the data recording to check whether the recorded data are completely present;
name and path of a destination file in which the data of reconstructed data streams are to be stored; and/or
start and end points in time of the data recording.

13. A method for generating at least one data stream via the method according to claim 1, the method comprising:
retrieving, from elementary data units stored in a manner distributed over at least two storage media or source files, at least two elementary data units from different storage media or from different source files based on metadata and arranged in a temporal sequence; and
generating the at least one data stream at least partially by the retrieved at least two elementary data units,
wherein:
(i) at least two data streams are at least partially generated from at least two elementary data units in each case, preferably based on the metadata, preferably each of the generated data streams being stored in a separate destination file, or at least two of the generated data streams being stored in a common file, and/or
(ii) a check is carried out as to whether all of the at least two storage media or all of the at least two source files are available, in particular for retrieving the elementary data units store thereon or therein.

14. An apparatus for data processing or for recording data, which is data-linked or data-linkable to one or multiple sensors, and/or which is data-linked or data-linkable to at least two storage media, the apparatus comprising a processor to carry out the method according to claim 1, and/or comprises an apparatus for data processing for reconstructing a data stream recorded with the aid of the apparatus, which is data-linked or data-linkable to at least two storage media.

15. A computer program product, comprising commands, which, when the program is executed by an apparatus for data processing carries out the method according to claim 1.
